(19) United States
(12) Patent Application Publication
(10) Pub. No.: US 2024/0407379 A1
(43) Pub. Date: Dec. 12, 2024

(54) METHOD FOR PRODUCING FERMENTED MILK PRODUCTS FOR AMBIENT STORAGE

(71) Applicant: Chr. Hansen A/S, Hoersholm (DK)

(72) Inventors: Hui Han, Beijing (CN); Mette Oehrstroem, Hoersholm (DK)

(73) Assignee: Chr. Hansen A/S, Hoersholm (DK)

(21) Appl. No.: 18/697,902

(22) PCT Filed: Oct. 3, 2022
(86) PCT No.: PCT/EP2022/077441

§ 371 Date: Apr. 2, 2024

(30) Foreign Application Priority Data
Oct. 4, 2021 (WO) PCT/CN2021/122506

(51) Int. Cl. A23C 9/123

(52) U.S. Cl. CPC A23C 9/1234; A23C 9/1238

(57) ABSTRACT

The present invention is in the field of dairy technology. It relates to methods for producing fermented milk products comprising live bacteria which products have no or low/reduced post-acidification when stored at ambient temperature. The invention furthermore relates to fermented milk products produced by the method.

### FIELD OF THE INVENTION

The present invention relates to methods for producing fermented milk products. In particular fermented milk products with low post-acidification comprising live bacteria for ambient storage.

### BACKGROUND OF THE INVENTION

Fermented milk products and methods for their production are known in the art. In general, fermented milk products require storage and distribution at cold temperatures to prevent further fermentation and acidification by the strains comprised in the starter culture after finalizing the production, i.e. post-acidification, as well as for reducing the activity of any unwanted microorganism that would cause spoilage of the product. In areas where cold storage and distribution are difficult or not desired methods have been developed for producing fermented milk products which are more or less stable at ambient temperatures. In particular, ways of controlling post-acidification has been addressed.

Methods comprising a step to inactivate strains of the starter culture and the unwanted microorganisms have been described and a heat treatment has traditionally been applied as the inactivation step. However heat may impact product attributes such as e.g. appearance, texture, flavour, etc.

In some countries legislation requires the presence of live bacteria in a product for it to be labeled as a “yogurt”. Furthermore, the presence of certain live bacteria such as e.g. probiotic bacteria in the product may provide the manufacturer a desired option for claiming health benefits. However the presence of live bacteria provides a challenge in particular at ambient temperature due to in particular post-acidification.

Use of lactose-deficient strains have been applied in some methods aiming at reducing post-acidification in the products made e.g.

U.S. Pat. No. 10,072,310 (Ling) Relates to a process of preparing fermented milk beverage keeping high viable cell count at ambient temperature comprising use of the lactose-deficient strain ATCC53103.

WO2005/089560 (Nestec S.A.) describes shelf-stable dairy products comprising living microorganisms which cannot use lactose as nutrient, and methods for manufacturing such products. However only one-step fermentation with the single strain CNCM I-2116 has been demonstrated.

WO2019/092064 (Tetra Laval Holdings & Finance S.A) describes methods for producing packages containing a fermented dairy product for ambient distribution comprising a live dedicated culture which is free of bacteria that can consume lactose.

WO2019/206754 (Chr. Hansen) describes a process for producing a milk product by fermenting a milk base with lactose-deficient strains and subsequently adding probiotic strains.

However, there is still a need for improved methods for producing fermented milk products comprising live bacteria which products have no or low/reduced post-acidification when stored at ambient temperature.

### SUMMARY OF THE INVENTION

The present invention provides a method for preparing a fermented milk product.

In a first aspect present invention provides a method for producing a fermented milk product with live bacteria comprising the steps of:
(a) Providing a milk base comprising at least one carbohydrate and a first culture comprising one or more lactic acid bacteria strains capable of metabolizing said carbohydrate and generating at least one monosaccharide;
(b) fermenting the milk base at a first temperature of no more than 45° C. for a period of time until a first target pH of no more than pH 4.7 is reached to obtain a first fermented milk base comprising the at least one monosaccharide;
(c) treating the first fermented milk base whereby the strains comprised in the first culture are inactivated or removed;
(d) adding a second culture comprising one or more lactic acid bacteria strains to the treated first fermented milk base, wherein said strains are lactose-deficient and capable of metabolizing the at least one monosaccharide generated during the first fermentation;
(e) fermenting the treated first fermented milk base at a second temperature of no more than 45° C. for a period of time until a second target pH of no more than pH 4.4 is reached to obtain a fermented milk product, wherein the second target pH is determined by depletion of the at least one monosaccharide and wherein the second target pH is lower than the first target pH.

In a second aspect present invention provides a fermented milk product manufactured by the method.

### Definitions

Prior to outlining the present invention in more details, a set of terms and conventions is defined:

The term “milk” is to be understood as the lacteal secretion obtained by milking an animal such as any mammal including but not limited to cow, sheep, goat, buffalo, camel, lama, mare, and deer. In a preferred embodiment, the milk is cow's milk.

“Homogenizing” as used herein means intensive mixing to obtain a soluble suspension or emulsion. If homogenization is performed prior to fermentation, it may be performed so as to break up the milk fat into smaller sizes so that it no longer separates from the milk. This may be accomplished by forcing the milk at high pressure through small orifices.

“Pasteurizing” as used herein means treatment of the milk base to reduce or eliminate the presence of live organisms, such as microorganisms. Preferably, pasteurization is attained by maintaining a specified temperature for a specified period of time. The specified temperature is usually attained by heating. The temperature and duration may be selected in order to kill or inactivate certain bacteria, such as harmful bacteria. A rapid cooling step may follow.

In the present context the term “starter culture” is a culture which is a preparation (composition) of one or more bacterial strains (such as lactic acid bacteria strains) to assist the beginning of the fermentation process in preparation of fermented products such as various foods, feeds and beverages.

In the present context, a “yoghurt starter culture” is a bacterial culture which comprises one or more Lactobacillus bulgaricus strains and one or more Streptococcus thermophilus strains. In accordance herewith, a “yoghurt” refers to a fermented milk product obtainable by inoculating and fermenting a milk base with a composition comprising a Lactobacillus bulgaricus and a Streptoccocus thermophilus strain.

The term “ambient temperature” or “room temperature” in the present context means a temperature above 10° C.; 15° C.; 20° C.; 25° C.; or between 10-50° C.; 10-40° C.; 10-30° C.; 15-45° C.; 15-35° C.; 15-25° C.; 20-40° C.; or 20-30° C.

In connection with lactic acid bacteria strains, the term “CFU” or “cfu” means colony forming units as determined by growth (forming a colony) on an MRS agar plate incubated at anaerobic conditions at 37° C. for 3 days. See in the examples for details used in connection with the invention.

### DETAILED DESCRIPTION OF THE INVENTION

Fermented milk products such as yogurt may be produced from a milk base that has been standardized with respect to fat and protein content, homogenized and pasteurized. In the general method the milk base is inoculated with a starter culture comprising selected microorganisms such as Lactic Acid Bacteria (LAB). The fermentation is conducted at specified conditions (time, temperature, oxygen, etc.) until a desired target pH is reached after which the fermentation is terminated typically by reducing the temperature. The fermented milk product is stored preferably cold often at 4° C. Fermented milk products are characterized by the specific starter cultures used for fermentation.

In the absence of cold transport and/or cold storage of the fermented milk product or where the cold-chain is imperfect unwanted acidification may continue after fermentation and result in reduced pH, i.e. post-acidification in the milk product. Post-acidification may amongst other things confer unwanted changes in the properties of the product such as in e.g. appearance, taste and texture. Furthermore depending on the extent of post-acidification viability of any bacteria present in the product may be affected leading to reduced viability or even dead bacteria.

Post-acidification caused by a starter culture may be prevented by inactivating the microorganisms comprised in the starter culture. However the desire for manufacturing a product with live bacteria such as e.g. probiotic bacteria necessitates addition of live bacteria after the inactivation step. The added live bacteria may at room temperature or ambient temperature continue the acidification in the milk product and confer a change of the said milk product.

The present invention relates to a two-step fermentation method for producing fermented milk products that are suitable for storage at ambient temperature. Current methods for preparing fermented milk products such as e.g. post-pasteurized yogurt (PPY) struggle to reduce post-acidification caused by live bacteria present in the final product. Surprisingly as demonstrated by the present invention acidification by the live bacteria added after post-pasturization can advantageously be utilized in the fermentation process to produce the milk product.

Thus, in one embodiment the invention relates to a method for producing a fermented milk product with live bacteria comprising the steps of:
(a) Providing a milk base comprising at least one carbohydrate and a first culture comprising one or more lactic acid bacteria strains capable of metabolizing said carbohydrate and generating at least one monosaccharide;
(b) fermenting the milk base at a first temperature of no more than 45° C. for a period of time until a first target pH of no more than pH 4.7 is reached to obtain a first fermented milk base comprising the at least one monosaccharide;
(c) treating the first fermented milk base whereby the strains comprised in the first culture are inactivated or removed;
(d) adding a second culture comprising one or more lactic acid bacteria strains to the treated first fermented milk base, wherein said strains are lactose-deficient and capable of metabolizing the at least one monosaccharide generated during the first fermentation;
(e) fermenting the treated first fermented milk base at a second temperature of no more than 45° C. for a period of time until a second target pH of no more than pH 4.4 is reached to obtain a fermented milk product, wherein the second target pH is determined by depletion of the at least one monosaccharide and wherein the second target pH is lower than the first target pH.

The milk base may be any raw and/or processed milk ingredient or other material derived from milk that can be subjected to fermentation according to the method of the invention. Thus, useful milk bases include, but are not limited to, solutions or suspensions of any milk or milk like products comprising protein, such as whole milk, full fat milk, fat-free milk, low fat milk, skim milk, buttermilk, lactose-reduced milk, concentrated milk, reconstituted milk powder, condensed milk, dried milk, whey, whey permeate, lactose, mother liquid from crystallization of lactose, whey protein concentrate, or cream. Obviously, the milk base may originate from any mammal, e.g. being substantially pure mammalian milk, or reconstituted milk powder. Preferably, at least part of the protein in the milk base are proteins naturally occurring in mammalian milk, such as casein or whey protein.

In one embodiment the invention relates to the method, wherein the milk base is derived from an animal such as e.g. a mammal. In one embodiment the invention relates to the method, wherein the mammal is selected from the group consisting of cow, sheep, goat, buffalo, camel, lama, mare, and deer. In a preferred embodiment, the mammal is a cow. Prior to fermentation, the milk base may be homogenized and pasteurized according to methods known in the art.

The milk base derived from mammals comprises lactose as the main carbohydrate. Lactose is hydrolysed into the monosaccharides glucose and galactose by the lactic acid bacteria during fermentation. If the lactic acid bacteria is not able to metabolize lactose i.e. is lactose-deficient it may be necessary to add a suitable carbohydrate to the milk base to obtain at least one carbohydrate for generating at least one monosaccharide available for the lactic acid bacteria of the second fermentation.

The term “lactose-deficient” are used in the context of the present invention to characterize lactic acid bacteria which partly or completely have lost the ability to use lactose as a source for maintaining cell viability or cell growth. Lactose-deficient bacteria are capable of metabolizing one or more carbohydrates selected from sucrose, galactose, glucose and/or other fermentable carbohydrates. Since these carbohydrates are not naturally present in sufficient amounts in milk to support fermentation by lactose-deficient bacteria they must be added to the milk base.

Suitable carbohydrates to be added are determined by the one or more lactic acid bacteria of the first culture and the monosaccharides that must be available for the one or more lactic acid bacteria of the second culture. Examples of suitable carbohydrates to be lactose, sucrose, maltose, or trehalose. Sucrose is hydrolysed into the monosaccharides glucose and fructose, maltose into glucose, and trehalose into glucose. In one embodiment the invention relates to the method wherein the at least one carbohydrate in the milk base are selected from lactose, sucrose, maltose, or trehalose. In one embodiment the invention relates to the method, wherein the at least one carbohydrate in the milk base is added to the milk base.

The amount of carbohydrates present in the milk base must be sufficient for the first fermentation to take place to generate the at least one monosaccharide that must be available for the second fermentation. However the amount of carbohydrates must not be in excess if the one or more lactic acid bacteria of the second culture are able to metabolize the carbohydrate. In the situation where the lactic acid bacteria of both the first and the second culture are able to metabolize the carbohydrate, the amount of said carbohydrate must be selected i.e. limited for the carbohydrate to be depleted after the first fermentation or alternatively to be depleted when the second fermentation has reached the second target pH. In one embodiment the invention relates to the method wherein the amount of the at least one carbohydrate is depleted during the first fermentation. In one embodiment the invention relates to the method wherein the amount of the at least one carbohydrate is depleted when the second fermentation has reached the second target pH.

The first fermentation starts when a first culture is added to the milk base. The first culture may be any starter culture such as e.g. a yogurt starter culture. The term “starter” or “starter culture” as used in the present context refers to a culture of one or more food-grade microorganisms in particular lactic acid bacteria, which are responsible for the acidification of the milk base. Starter cultures may be fresh, frozen or freeze-dried. In one embodiment the invention relates to the method wherein the one or more lactic acid bacteria strains of the first culture are selected from the genus Streptococcus such as S. thermophilus, or the genus Lactobacillus such as L. delbrueckii subsp. bulgaricus.

The one or more lactic acid bacteria strains of the first culture may be lactose-deficient. Examples of suitable lactose-deficient strains may be found in WO2015/193459. In one embodiment the invention relates to the method wherein the one or more lactic acid bacteria strains of the first culture are lactose-deficient. In one embodiment the invention relates to the method wherein the lactose-deficient strain of the first culture is selected from the group consisting of: DSM28952, DSM28953, DSM28910, DSM32600, DSM32599.

The first fermentation is terminated when sufficient amount of the at least one monosaccharide has been generated. The first fermentation is terminated when the first target pH has been reached. The first target pH must be higher than the second target pH and must be selected to provide a pH range allowing for further acidification during the second fermentation. In one embodiment the invention relates to the method wherein the first target pH is no more than pH 4.70:4.65; 4.60; 4.55; 4.50; 4.45; 4.40; or in the range of pH 4.70-4.00; 4.70-4.10; 4.70-4.20; 4.70-4.30; 4.70-4.40; 4.70-4.45; 4.65-4.50; 4.60-4.55; or is about 4.70:4.65; 4.60; 4.55; 4.50; 4.45; or 4.40.

Temperature affects the speed of fermentation and should preferably be kept stable or constant at a defined temperature during the first fermentation. In one embodiment the invention relates to the method, wherein the first temperature is no more than 25; 30; 35; 36; 37; 38; 39; 40; 41; 42; 43; 44; 45° C.; or in the range of 20-45; 25-45; 30-45; 40-45; 25-40; 30-40; 35-40° C.; or is about 20; 25; 30; 35; 36; 37; 38; 39; 40; 41; 42; 43; 44; 45° C.

In order to terminate and prevent further fermentation by the first culture it must be inactivated or removed. The first fermented milk base may be inactivate in several ways. In one embodiment the invention relates to the method wherein the treatment of the first fermented milk base is a treatment with heat, ultrasound, radiation such as e.g. UV radiation, bactofugation, or microfiltration. Treatment with heat or heat treatment may also be named as post-pasteurization. In one embodiment the invention relates to the method wherein the heat treatment is conducted in the range of 65-75° C. for at least 1-30 minutes; or at at least 60; 65; 70; or 75° C. for 1; 5; 10; 15; 20; 25; or 30 minutes; or in the range of 70-90 for 10-50 seconds; or at at least 70; 75; 80; 85; or 90° C. for at least 10; 15; 20; 25; 30; 35; 40; 45; or 50 seconds; or in the range of 65-90° C.; 70-85° C.; 75-80 for 10-50 seconds; or for 75° C. for 25 seconds; 75° C. for 50 seconds.

In one embodiment the invention relates to the method wherein the first fermentation is terminated by a cooling step. Preferably the temperature used for the cooling step is about 4° C., such as 2° C., 3° C., 4° C., 5° C., or 6° C.

Preferably the second culture is added at aseptic condition, i.e. without introducing or introducing a minimum of any microorganism other than the one or more lactic acid bacteria of the second culture. The second culture may be added as one or more bulks or as a continuously feed into to the production line. The second culture may be added in the form of a liquid culture, frozen culture, or freeze-dried culture. Preferably the culture is a concentrated culture.

The one or more lactic acid bacteria strains of the second culture are lactose-deficient and metabolizes the at least one monosaccharide generated during the first fermentation. Thus the second fermentation is terminated when the at least one monosaccharide has been depleted from the first fermented milk base and the second target pH has been reached. In one embodiment the invention relates to the method wherein the second target pH is no more than pH 4.5; 4.4; 4.3; 4.2; 4.1; 4.0; 3.9; 3.8; 3.7; 3.6; 3.5 or is in the range of pH 4.50-3.50; 4.50-4.05; 4.45-4.10; 4.45-4.15; 4.40-4.20; 4.40-4.25; 4.35-4.30; 4.00-3.50; 3.95-3.50; 3.90-3.55; 3.85-3.60; 3.80-3.65; 3.75-3.60; or is about pH 4.40; 4.35; 4.30; 4.25; 4.20; 4.15; 4.10; 4.05; 4.00; 3.90; 3.80; 3.70; 3.60; 3.50.

In one embodiment the invention relates to the method wherein the one or more lactic acid bacteria of the second culture is selected from the group consisting of bacteria of the genus Lactobacillus, such as Lactobacillus acidophilus, Lacticaseibacillus paracasei, Lacticaseibacillus rhamnosus, Lacticaseibacillus casei, Lactobacillus delbrueckii, Lactiplantibacillus plantarum, Limosilactobacillus fermentum, Limosilactobacillus reuteri and Lactobacillus johnsonii; the genus Bifidobacterium, such as Bifidobacterium longum, Bifidobacterium Bifidobacterium adolescentis, bifidum, Bifidobacterium breve, Bifidobacterium animalis subsp. lactis, Bifidobacterium dentium, Bifidobacterium catenulatum, Bifidobacterium angulatum, Bifidobacterium magnum, Bifidobacterium pseudocatenulatum and Bifidobacterium infantis; or the genus Streptococcus such as S. thermophilus.

Consumption of probiotic bacteria is considered beneficial for the health of an individual. Thus a certain amount of live probiotic bacteria in the fermented milk product is desirable. In one embodiment the invention relates to the method wherein the one or more lactic acid bacteria of the second culture is a probiotic bacteria.

The one or more lactic acid bacteria strains of the second culture are lactose-deficient and may be selected from the group consisting of: ATCC53103, CNCM I-2116, and DSM16572. In one embodiment the invention relates to the method wherein the bacteria is ATCC53103, CNCM I-2116, and/or DSM16572.

The method of the invention have shown to result in a fermented milk product with no or low/reduced post-acidification. In the examples this is shown as change in the acidification in the storage period after time t1. This may result in a change in pH measured in the product. The change in pH may be an increase in pH or a decrease in pH. Post-acidification is always indicated as a decrease in pH.

In one embodiment the invention relates to the method wherein the pH of the fermented milk product changes less that 0.80; 0.70; 0.60; 0.50; 0.40; 0.35; 0.30, 0.25, 0.20, 0.18, 0.16, 0.14, 0.12, 0.10, 0.09, 0.08, 0.07, 0.06, 0.05, 0.04, 0.03, 0.02 or 0.01 pH units after storage for 6 month at 25° C. In one embodiment the invention relates to the method wherein the pH of the fermented milk product changes less that 0.80; 0.70; 0.60; 0.50; 0.40; 0.35; 0.30, 0.25, 0.20, 0.18, 0.16, 0.14, 0.12, 0.10, 0.09, 0.08, 0.07, 0.06, 0.05, 0.04, 0.03, 0.02 or 0.01 pH units after storage for 2 month at 37° C. or after storage for 1 month at 42° C.

In one embodiment the invention relates to the method wherein fermented milk product comprise at least 1.0E+03; 1.0E+04; 1.0E+05; 1.0E+06; 1.0E+07; 1.0E+08; 1.0E+09; 1.0E+10 cfu/g live bacteria after storage for 6 month at 25° C. In one embodiment the invention relates to the method wherein fermented milk product comprises at least 1.0E+06 cfu/g live bacteria after storage for 2 month at 37° C. or after storage for 1 month at 42° C. In one embodiment the invention relates to the method wherein fermented milk product comprises at least 1.0E+07 cfu/g live bacteria after storage for 2, 3, 4, or 5 weeks at 45° C. In one embodiment the invention relates to the method wherein the live bacteria comprises or contains probiotic bacteria.

In one embodiment the invention relates to the method wherein one or more lactic acid bacteria of the second culture are able to proliferate and increase the cell count during the second fermentation, or both during and after the second fermentation. In one embodiment the invention relates to the method wherein the cell count is increased with 0.5; 1.0; 1.5; 2.0; 2.5; or 3.0 logs.

In one embodiment the invention relates to the method further comprising addition of flavoring agents, thickening agents, emulsifying agents and/or stabilizing agents, such as e.g. pectin (e.g. HM pectin, LM pectin), gelatin, CMC, Soya Bean Fiber/Soya Bean Polymer, starch, modified starch, carrageenan, alginate, agar, and guar gum. In one embodiment the invention relates to the method further comprising addition of a sweetener, such as a chemical/artificial sweetener (sucralose, isomaltulose, acesulfame potassium, etc), sugar alcohol (Maltitol or Isomaltitol (12-carbon), Erythritol (4-carbon), Xylitol (5-carbon), Sorbitol (6-carbon), etc.). Sugar alcohols differ in the number of carbons and in one embodiment the invention relates to the method wherein the sugar alcohol is selected from a group consisting of a 4-carbon, a 5-carbon, a 6-carbon, or a 12-carbon sugar alcohol. In one embodiment the invention relates to the method further comprising the sugar alcohols erythritol and/or maltitol. In one embodiment the mass ratio of erythritol: maltitol is (0.5-4.0):(0-4.0). The sugar alcohol may be used in a total amount of 0.5-8.0, 2.5-6.0, or 4.5 w/w % based on the total weight of the fermented milk product.

In one embodiment the invention relates to a fermented milk product manufactured by the method. The term “fermented milk product” as used herein refers to a food or feed product wherein the preparation of the food or feed product involves fermentation of a milk base with lactic acid bacteria according to the invention. “Fermented milk product” as used herein includes but is not limited to dairy products such as yogurt. In one embodiment the invention relates to a fermented milk product which is a food or feed product. In one embodiment the invention relates to a fermented milk product which is a dairy product such as Yogurt (set or stirred); Greek yogurt; Yogurt based products such as fruit yogurt, and yogurt based beverages; Buttermilk; Kefir; Labneh, Quark. Preferably, the fermented milk product is a yogurt.

In one embodiment the invention relates to the fermented milk product wherein said product is an ambient storage fermented milk product. The term “ambient storage fermented milk product” means a fermented milk product, which is suitable for ambient storage for a period of time. Storage period may be between 1-12 month, such as 1, 2, 3, 4, 5, 6, 7, 8, 9, 10, 11, or 12 month.

The fermented milk product typically contains protein in a level of between 2.0-3.5% w/w. The fermented milk product may be a low protein product with a protein level of between 1.0-2.0% w/w. Alternatively, the fermented milk product may be a high protein product with a protein level of above 3.5, or 5.1% w/w e.g between 3.5-5.1%, 3.5-10.5% or 5.1-10.5% w/w. The protein may be derived from milk such as whey or casein.

It is recommended to consume a certain amount of probiotic bacteria to obtain a health benefit. Thus, it is desired that the fermented milk product comprises a certain level of probiotic bacteria. In one embodiment the invention relates to the fermented milk product wherein said product comprises probiotic bacteria of at least 1.0E+05; 1.0E+06; 1.0E+07; 1.0E+08; 1.0E+09; 1.0E+10; 1.0E+11; 1.0E+12 cfu/serving.

### Taxonomy

It will be appreciated that the Lactobacillus genus taxonomy was updated in 2020. The new taxonomy is disclosed in Zheng et al. 2020 Int. J. Syst. Evol. Microbiol. DOI 10.1099/ijsem.0.004107 and will be cohered to herein if not otherwise indicated. For the purpose of the present invention, the table below presents a list of new and old names of some Lactobacillus species relevant to the present invention.

TABLE 1
New and old names of Lactobacillus species
relevant to the present invention.

| Old Name | New Name |
|---|---|
| Lactobacillus reuteri | Limosilactobacillus reuteri |
| Lactobacillus rhamnosus | Lacticaseibacillus rhamnosus |
| Lactobacillus salivarius | Ligilactobacillus salivarius |
| Lactobacillus casei | Lacticaseibacillus casei |
| Lactobacillus paracasei | Lacticaseibacillus paracasei |
| Lactobacillus plantarum | Lactiplantibacillus plantarum |
| Lactobacillus fermentum | Limosilactobacillus fermentum |

TABLE 2
Strains.

| Strain | Reference |
|---|---|
| ATCC53103 | US10072310 |
| CNCM I-2116 | WO2005/089560 |
| DSM16572 | WO2017/194650 |
| DSM28910 | WO2015/193459 |
| DSM28952 | WO2015/193459 |
| DSM28953 | WO2015/193459 |
| DSM32599 | WO2019/043115 |
| DSM32600 | WO2019/043115 |

### EXAMPLES

### Example 1—YF-L904 & LGG

Prepare defined milk base for two-step fermentation ambient yoghurt with live bacteria. The defined milk base is suitable for using normal yoghurt culture as the first fermentation culture. In this defined milk base fermentation, normal yoghurt culture uses lactose to produce lactic acid, meanwhile galactose is left in yoghurt. Stopping fermentation at different pH, the amount of galactose will be different. Apply heat treatment to inactivate the first culture, aseptically dosing the second lactose negative culture LGG into heat treated yoghurt, LGG use galactose left from the first fermentation to continue decrease pH, when galactose finished, the pH of final yoghurt stays in a stable range, meanwhile, LGG grows to high cell count and keeps stable at ambient storage.

### Materials:

TABLE 3
Milk base.

| ingredient | specification | w/w % |
|---|---|---|
| Fresh milk | Protein 3.0%, fat 3.4% | 93.6% |
| Maltitol-P200 | Roquette | 3.5% |
| erythritol | Cargill | 1.0% |
| MS starch | Roquette 5025 | 1.5% |
| WPC80 | LACPRODAN 80 | 0.4% |
| Pectin | CP Kelco 106 AS-YA | 0.1% |
| Agar | Libangda YN-03 | 0.1% |

### Cultures

F-DVS YF-L904 (batch 3551191 Chr Hansen)

F-DVS LGG® (batch 3584797 Chr Hansen)

### Method:

Milk base was prepared according to the table above and pasteurized at 134° C. for 4 seconds.

First fermentation—inoculate YF-L904 100 u/T (units/ton) into milk base, ferment at 43° C. until the first target pH 4.7, 4.6, or 4.5 was reached.

Break curd and heat treat the three different pH yoghurt bases at 75° C. for 25 seconds.

Second fermentation—aseptically inoculate F-DVS LGG into the three different pH pasterized yoghurt, Dosage 100 u/T (time t0). Conduct the second fermentation at 25° C., 30° C., or 35° C. until a stable pH was reached.

Storage—at an ambient temperature of 25° C.

The cell count of L. rhamnosus, LGG® was determined by using Difco MRS agar, pour plate method with anaerobic incubation at 37° C. for 3 days.

### Results:

TABLE 4
Post-acidification for second fermentation at 35° C.

| | Day 0 | Day 1 | Day 2 | Day 3 | Day 4 | Day 5 | Day 6 |
|---|---|---|---|---|---|---|---|
| YF-L904PPY (4.7) + LGG | 4.86 | 4.57 | 4.44 | 4.38 | 4.36 | 4.35 | 4.34 |
| YF-L904PPY (4.6) + LGG | 4.83 | 4.49 | 4.35 | 4.29 | 4.27 | 4.26 | 4.26 |
| YF-L904PPY (4.5) + LGG | 4.56 | 4.32 | 4.15 | 4.09 | 4.07 | 4.05 | 4.05 |

TABLE 5
Post-acidification for second fermentation at 30° C.

| | Day 0 | Day 1 | Day 2 | Day 3 | Day 4 | Day 5 | Day 6 |
|---|---|---|---|---|---|---|---|
| YF-L904PPY (4.7) + LGG | 4.74 | 4.57 | 4.47 | 4.39 | 4.34 | 4.32 | 4.31 |
| YF-L904PPY (4.6) + LGG | 4.76 | 4.57 | 4.45 | 4.36 | 4.32 | 4.29 | 4.28 |
| YF-L904PPY (4.5) + LGG | 4.56 | 4.42 | 4.29 | 4.20 | 4.15 | 4.13 | 4.12 |

TABLE 6
Post-acidification for second fermentation at 25° C.

| | Day | Day | Day | Day | Day | Day | Day | Day | Day | Day |
|---|---|---|---|---|---|---|---|---|---|---|
| | 0 | 1 | 2 | 3 | 4 | 5 | 6 | 7 | 8 | 9 |
| YF-L904PPY | 4.78 | 4.70 | 4.61 | 4.55 | 4.49 | 4.45 | 4.42 | 4.41 | 4.40 | 4.39 |
| (4.7) + LGG | | | | | | | | | | |
| YF-L904PPY | 4.75 | 4.65 | 4.54 | 4.47 | 4.40 | 4.37 | 4.34 | 4.32 | 4.31 | 4.31 |
| (4.6) + LGG | | | | | | | | | | |
| YF-L904PPY | 4.56 | 4.51 | 4.42 | 4.34 | 4.27 | 4.23 | 4.20 | 4.19 | 4.17 | 4.16 |
| (4.5) + LGG | | | | | | | | | | |

TABLE 7
LGG count

| | 25° C. | | 30° C. | | 35° C. | |
|---|---|---|---|---|---|---|
| | D + 1 | D + 3 | D + 1 | D + 3 | D + 1 | D + 2 |
| YF-L904PPY(4.7) + LGG | 1.6 | 3.8 | 1.7 | 4.8 | 3.1 | 6.0 |
| (E+08 cfu/g) | | | | | | |
| YF-L904PPY(4.6) + LGG | 1.8 | 5.0 | 1.9 | 4.7 | 3.0 | 5.4 |
| (E+08 cfu/g) | | | | | | |
| YF-L904PPY(4.5) + LGG | 1.4 | 4.5 | 1.5 | 4.1 | 2.2 | 5.0 |
| (E+08 cfu/g) | | | | | | |

YF-L904 hydrolyse lactose naturally present in the milk to glucose and galactose. Glucose is metabolized and galactose is left in the milk base. LGG is able to metabolize galactose.

A different first first target pH leads to a different second target pH. The higher pH the first fermentation is terminated, the higher pH the second fermentation reaches a stable pH. Thus the first target pH should be determined according to the requirements of the final product. LGG reaches a stable pH faster at a high temperature during the second fermentation as compared to a lower temperature (35° C. vs 30° C. and 25° C.). LGG achieves a level of cell counts >1.0E+08 cfu/g at all second fermentation temperatures.

### Example 2—Acidifix & LGG, Effect of Temperature During 2. Fermentation

Milk base with limited amount of sugar (0.75%) was prepared in this experiment. 1st fermentation was carried out with Acidifix 1.0 to a stable pH. 2nd fermentation was carried out by LGG. 2nd fermentation cultures metabolizes the monosaccharide generated during the first fermentation to achieve a stable pH. 2nd fermentation was carried out at 25° C., 33° C. and 40° C. until a stable pH. Products were then stored at 25° C. to check for cell count and post acidification at different interval.

### Materials:

TABLE 8
Content of the milk base.

| Ingredient | Specification | w/w % |
|---|---|---|
| Fresh Milk | 3.8% fat, 3.15% protein | 79.00 |
| Low Fat Milk | 1.2% fat, 3.15% protein | 13.60 |
| Skim Milk Powder | Fonterra, Low Heat | 0.55 |
| Sugar (sucrose) | Refined Sugar | 0.75 |
| Maltitol | Maltidex 16385 | 3.50 |
| Erythritol | Zerose 16952 | 1.00 |
| Clearam CJ 5025 | Roquette | 1.50 |
| Pectin 106-AS YA | CP Kelco | 0.10 |

### Cultures:

F-DVS YoFlex® Acidifix™ 1.0 (batch 3586293, Chr. Hansen A/S)

F-DVS LGG® (batch 3584797, Chr. Hansen A/S)

### Method:

Milk base was prepared according to the table above and pasteurized at 134° C. for 4 seconds.

First fermentation—Milk base comprising a limited amount of sucrose, i.e. 0.75 w/w % were fermented with Acidifix 1.0 100 u/t milk base at 43° C. until sugar was depleted and a stable pH i.e. the first target pH at 4.50 was reached.

Heat treatment—at 75° C. for 49.2 seconds.

Second fermentation—Lactose-deficient LGG in the concentrations 3.5E+06 cfu/g LGG (1) or 9.0E+06 cfu/g LGG (2) were added to the fermented milk base comprising the monosaccharide fructose generated during the first fermentation (time t0) and fermented at 25° C., 30° C., or 40° C. until a stable pH was reached at a second target pH at approximately pH 4.3 (time t1).

Storage—at an ambient temperature of 25° C.

### Results:

TABLE 9
pH over time for the method according to the
invention wherein the second fermentation is
conducted at a temperature of 25° C., 33° C. or 40° C.

| 2. Culture | t0 | t1 | Day 30 | Week 7 |
|---|---|---|---|---|
| LGG(1) 25° C. | 4.50 | 4.32 | 4.38 | 4.38 |
| LGG(2) 25° C. | 4.50 | 4.34 | 4.40 | 4.38 |
| LGG(1) 33° C. | 4.50 | 4.28 | — | 4.35 |
| LGG(2) 33° C. | 4.50 | 4.34 | — | 4.38 |
| LGG(1) 40° C. | 4.50 | 4.32 | — | 4.37 |
| LGG(2) 40° C. | 4.50 | 4.34 | — | 4.38 |

TABLE 10
Cell count over time for the method according to the
invention wherein the second fermentation
is conducted at a temperature of 25° C., 33° C. or 40° C.

| 2. Culture | t0 | t1 | Day 30 | Week 7 |
|---|---|---|---|---|
| LGG(1) 25° C. | 3.5E+06 | 2.2E+08 | 1.3E+08 | 9.5E+07 |
| LGG(2) 25° C. | 9.1E+06 | 2.1E+08 | 1.5E+08 | 1.2E+08 |
| LGG(1) 33° C. | 3.5E+06 | 2.5E+08 | — | 8.0E+07 |
| LGG(2) 33° C. | 9.1E+06 | 2.0E+08 | — | 9.8E+07 |
| LGG(1) 40° C. | 3.5E+06 | 2.2E+08 | — | 8.3E+07 |
| LGG(2) 40° C. | 9.1E+06 | 2.1E+08 | — | 8.1E+07 |

Fermentation/acidification by the second culture is part of the method of the invention. LGG ferment/acidify the heat treated fermented milk base as is apparent from the difference in pH between pH t0 and pH t1. No further fermentation (post-acidification) takes place during storage as can be observed by comparing pH t1 and pH week 7. Stable pH was observed for all temperatures tested. Stable pH is crucial to keep the taste of the product during shelf-life.

LGG proliferated at both LGG inoculation dosage tested during the second fermentation as is apparent from comparing the cell counts at to and t1. Storage for 7 weeeks at ambient temperature (25° C.) shows that the cell count of the product is keep stable. Stable cell count provides adequate amount of live bacteria for end users.

### Example 3—Storage Stability at Ambient Temperature (25° C.)

### Materials:

TABLE 11
Milk base

| Ingredient | Specification | w/w % |
|---|---|---|
| Fresh milk | Protein 3.0%, fat 3.4% | 92.65% |
| sucrose | Taigu | 0.75% |
| Maltitol-P200 | Roquette | 3.5% |
| erythritol | Cargill | 1.0% |
| MS starch | Roquette 5025 | 1.5% |
| WPC80 | LACPRODAN 80 | 0.4% |
| Pectin | CP Kelco 106 AS-YA | 0.1% |
| Agar | Libangda YN-03 | 0.1% |

### Cultures

F-DVS YoFlex® Acidifix™ 1.0 (batch 3586293 Chr Hansen A/S)

F-DVS LGG® (batch 3584797 Chr Hansen A/S)

### Method:

Milk base was prepared according to the table above and pasteurized at 134° C. for 4 seconds.

First fermentation—inoculate Acidifix 100 u/T (units/ton) into milk base, ferment at 43° C. until the first target pH 4.50 was reached.

Break curd and heat treat yoghurt base at 75° C. for 25 seconds.

Second fermentation—inoculate aseptically F-DVS LGG with two dosage. Dosage (1) 100 u/T, 7.0E+06 cfu/g. Dosage (2) 200 u/T, 1.2E+07 cfu/g were added to heat treated yogurt base prepared by the first fermentation (time t0). Conduct the second fermentation at 25° C., 33° C., 40° C. until a stable pH was reached at a second target pH at approximately pH 4.3 (time t1).

Storage—at an ambient temperature of 25° C.

### Results:

The same cell counts were obtained for the three temperatures tested. Thus storage stability data from one temperature (25° C.) is shown in the table below.

TABLE 12
pH and cell count during storage at ambient temperature (25° C.)

| | t1 | D + 7 | D + 14 | D + 21 | D + 28 | Week 8 |
|---|---|---|---|---|---|---|
| LGG 100 u/t | | | | | | |
| pH | 4.29 | 4.25 | 4.26 | 4.31 | 4.34 | 4.29 |
| Cell count (E+08) | 1.30 | 1.70 | 1.00 | 0.57 | 0.55 | 0.61 |
| LGG 200 u/t | | | | | | |
| pH | 4.30 | 4.28 | 4.26 | 4.33 | 4.33 | 4.32 |
| Cell count (E+08) | 1.50 | 2.00 | 1.30 | 0.39 | 0.38 | 0.54 |

Stable pH was reached at all temperatures tested. At both LGG inocuation dosages higher cell count (>1.0E+8 cfu/g) at t1 than inoculation dosage were reached. After two month ambient storage (25° C.) pH and cell count of the products are stable.

### Example 4—Shelf Life of Six Different Fermented Milk Products

1^{st} fermentation were carried out with 2 different type of cultures (Acidifix 1.0 and YF-L 904). 2^{nd} fermentation was carried out by LGG or Fresh Q2. 2^{nd} fermentation cultures metabolizes the monosaccharide generated during the first fermentation to achieve a stable pH. 2nd fermentation was carried out at 25° C. for 3 days, or until a stable pH. Products were then stored at 25° C. to check for cell count and post acidification at different interval.

### Materials:

Three different milkbases with different amount of sucrose were used and prepared according to the tables below. No sucrose, limited amount of sucrose (0.75%) and excess amount of sucrose (7.00%).

TABLE 13
Milk Base 1

| Ingredient | Specification | w/w % |
|---|---|---|
| Fresh Milk | 3.8% fat, 3.15% protein | 79.70 |
| Low Fat Milk | 1.2% fat, 3.15% protein | 13.60 |
| Skim Milk Powder | Fonterra, Low Heat | 0.60 |
| Maltitol | Maltidex 16385 | 3.50 |
| Erythritol | Zerose 16952 | 1.00 |
| Clearam CJ 5025 | Roquette | 1.50 |
| Pectin 106-AS YA | CP Kelco | 0.10 |

TABLE 14
Milk Base 2

| Ingredient | Specification | w/w % |
|---|---|---|
| Fresh Milk | 3.8% fat, 3.15% protein | 79.05 |
| Low Fat Milk | 1.2% fat, 3.15% protein | 13.60 |
| Skim Milk Powder | Fonterra, Low Heat | 0.50 |
| Sugar (sucrose) | Refined Sugar | 0.75 |
| Maltitol | Maltidex 16385 | 3.50 |
| Erythritol | Zerose 16952 | 1.00 |
| Clearam CJ 5025 | Roquette | 1.50 |
| Pectin 106-AS YA | CP Kelco | 0.10 |

TABLE 15
Milk Base 3

| Ingredient | Specification | w/w % |
|---|---|---|
| Fresh Milk | 3.8% fat, 3.15% protein | 79.70 |
| Low Fat Milk | 1.2% fat, 3.15% protein | 11.00 |
| Skim Milk Powder | Fonterra, Low Heat | 0.70 |
| Sugar (sucrose) | Refined Sugar | 7.00 |
| Clearam CJ 5025 | Roquette | 1.50 |
| Pectin 106-AS YA | CP Kelco | 0.10 |

The following cultures were used for fermentation and added at a concentration of 100 u/t.

F-DVS YF-L904 (batch 3551191, Chr. Hansen A/S).

F-DVS YoFlex® Acidifix™ 1.0 (batch 3586293, Chr. Hansen A/S).

F-DVS LGG® (batch 3584797, Chr. Hansen A/S).

F-DVS FQ®2 (batch 3589655, Chr. Hansen A/S).

### Method:

Milk base prepared according to the tables above were pasteurized at 134° C. for 4 seconds. The fermentation were set up according to the table below without sucrose (S1), limited amount of sucrose (S2-S3) or with (S4-S6) excess of sucrose. YF-L904 and FQ2 hydrolyze lactose present in the milk base to glucose and galactose where glucose is consumed and galactose is left in the milk base. Acidifix and LGG is lactose-deficient and hydrolyze sucrose added to the milk base to glucose and fructose where glucose is consumed and fructose is left in the milk base. LGG may grow on fructose and very slowly on galactose.

First fermentation—100 units/ton of 1. Culture were inoculated in the milk base according to the table below. Fermentation were conducted at 43° C. until the first target pH 4.50 was reached.

Break curd and heat treat yoghurt base at 75° C. for 49.2 seconds.

Second fermentation—5.0E+06 cfu/g of 2. Culture were inoculated in the heat treated yogurt base prepared by the first fermentation (time t0). The second fermentation were conducted at 25° C. until a stable pH was reached at a second target pH at approximately pH 4.3 (time t1).

Storage—at an ambient temperature of 25° C.

TABLE 16
Fermentation set up.

| Set up no. | Milk base | Sucrose | 1. Culture | 2. Culture |
|---|---|---|---|---|
| S1 | MB1 | — | F-DVS YF-L904 | F-DVS LGG |
| S2 | MB2 | 0.75% | F-DVSAcidifix 1.0 | F-DVS LGG |
| S3 | MB2 | 0.75% | F-DVSAcidifix 1.0 | F-DVS FQ 2 |
| S4 | MB3 | 7.00% | F-DVSAcidifix 1.0 | F-DVS LGG |
| S5 | MB3 | 7.00% | F-DVSAcidifix 1.0 | F-DVS FQ 2 |
| S6 | MB3 | 7.00% | F-DVS YF-L 904 | F-DVS LGG |

### Results:

TABLE 17
pH and Cell count for the fermentation Set up 1-6.

| Sample | pH t0 | pH t1 | Cell count t0 | Cell count t1 |
|---|---|---|---|---|
| S1 | 4.51 | 4.20 | 4.2E+6 | 3.4E+8 |
| S2 | 4.48 | 4.27 | 4.5E+6 | 2.5E+8 |
| S3 | 4.48 | 4.11 | 5.1E+6 | 4.0E+8 |
| S4 | 4.50 | 4.06 | 4.8E+6 | 3.0E+8 |
| S5 | 4.50 | 4.10 | 5.3E+6 | 4.0E+8 |
| S6 | 4.50 | 4.00 | 4.7E+6 | 5.8E+8 |

TABLE 18a
pH during storage at 42° C.

| Sample | t1 | Day 7 | Day 14 | Day 21 | Day 28 |
|---|---|---|---|---|---|
| S1 | 4.20 | 4.17 | 4.15 | 4.17 | 4.16 |
| S2 | 4.27 | 4.28 | 4.29 | 4.31 | 4.28 |
| S3 | 4.11 | 3.71 | 3.51 | 3.53 | 3.49 |
| S4 | 4.06 | 3.61 | 3.57 | 3.29 | 3.38 |
| S5 | 4.10 | 3.48 | 3.35 | 3.32 | 3.40 |
| S6 | 4.00 | 3.48 | 3.38 | 3.27 | 3.39 |

TABLE 18b
Cell count during storage at 42° C.

| Sample | t1 | Day 7 | Day 14 | Day 21 | Day 28 |
|---|---|---|---|---|---|
| S1 | 3.4E+8 | 1.6E+8 | 7.6E+5 | 9.5E+5 | 6.3E+5 |
| S2 | 2.5E+8 | 1.0E+8 | 9.4E+7 | 6.4E+7 | 3.0E+7 |
| S3 | 4.0E+8 | 4.9E+7 | <1.0E+4 | <100 | 0 |
| S4 | 3.0E+8 | 5.8E+8 | 7.1E+8 | <1.0E+5 | <1.0E+3 |
| S5 | 4.0E+8 | 1.6E+8 | 1.6E+8 | <1.0E+5 | <1.0E+3 |
| S6 | 5.8E+8 | 7.3E+8 | 5.8E+8 | <1.0E+5 | <1.0E+3 |

TABLE 19a
pH during storage at 37° C.

| Sample | t1 | Day 14 | Day 28 | Day 42 | Day 56 |
|---|---|---|---|---|---|
| S1 | 4.20 | 4.14 | 4.16 | 4.23 | 4.21 |
| S2 | 4.27 | 4.25 | 4.28 | — | 4.41 |
| S3 | 4.11 | 3.46 | 3.38 | 3.45 | 3.44 |
| S4 | 4.06 | 3.35 | 3.37 | 3.35 | 3.27 |
| S5 | 4.10 | 3.38 | 3.32 | 3.31 | 3.21 |
| S6 | 4.00 | 3.33 | 3.33 | 3.32 | 3.23 |

TABLE 19b
Cell count during storage at 37° C.

| Sample | t1 | Day 14 | Day 28 | Day 42 | Day 56 |
|---|---|---|---|---|---|
| S1 | 3.4E+8 | 8.0E+7 | 4.6E+6 | 5.3E+6 | 9.2E+6 |
| S2 | 2.5E+8 | 1.0E+8 | 7.0E+7 | 1.5E+7 | 2.8E+7 |
| S3 | 4.0E+8 | 4.3E+7 | 7.8E+5 | <1000 | <10 |
| S4 | 3.0E+8 | 5.7E+7 | 5.6E+6 | <1000 | <10 |
| S5 | 4.0E+8 | <1.0E+4 | <1000 | <10 | <10 |
| S6 | 5.8E+8 | 1.4E+6 | 1.4E+6 | <1000 | <10 |

TABLE 20a
pH during storage at 25° C.

| Sample | t1 | Day 28 | Day 56 | 3 Mth | 4 Mth | 5 Mth | 6 Mth |
|---|---|---|---|---|---|---|---|
| S1 | 4.20 | 4.16 | 4.18 | 4.14 | 4.14 | 4.15 | 4.13 |
| S2 | 4.27 | 4.30 | 4.27 | 4.25 | 4.24 | 4.25 | 4.26 |
| S3 | 4.11 | 3.52 | 3.44 | 3.32 | 3.33 | 3.33 | 3.31 |
| S4 | 4.06 | 4.07 | 3.40 | 3.35 | 3.38 | 3.39 | 3.38 |
| S5 | 4.10 | 3.55 | 3.67 | 3.40 | 3.44 | 3.42 | 3.39 |
| S6 | 4.00 | 3.81 | 3.24 | 3.26 | 3.27 | 3.25 | 3.24 |

TABLE 20b
Cell count during storage at 25° C.

| Sample | t1 | Day 28 | Day 56 | 3 Mth | 4 Mth | 5 Mth | 6 Mth |
|---|---|---|---|---|---|---|---|
| S1 | 3.4E+8 | 7.0E+7 | 8.9E+7 | 1.9E+6 | 3.3E+6 | 4.6E+6 | 8.5E+6 |
| S2 | 2.5E+8 | 4.8E+7 | 1.3E+8 | 6.4E+6 | 3.5E+7 | 3.4E+7 | 3.7E+7 |
| S3 | 4.0E+8 | 2.4E+8 | 2.2E+8 | 1.0E+5 | <1000 | <10 | <10 |
| S4 | 6.8E+8 | 5.8E+8 | 7.7E+6 | 3.6E+6 | <1.0E+4 | <10 | <10 |
| S5 | 3.6E+8 | 3.0E+8 | 9.5E+7 | 1.1E+8 | 9.0E+5 | 8.7E+2 | <10 |
| S6 | 6.1E+8 | 4.0E+8 | 1.3E+8 | 2.9E+6 | 3.0E+4 | <10 | <10 |

The method according to the invention is illustrated in S1 and S2 where post-acidification during storage is very low or absent. The controls S3 and S5 shows that if a lactose-fermenting culture is used as the second culture post-acidification occurs. In the controls S4, S5 and S6 sucrose has been added in excess and is thus available for the second culture for post-acidification.

### Example 5—Post-Acidification in the Presence of Sweeteners

Products were prepared according to the invention in the presence of different sweeteners and stored at 25° C. during which acidification were determined at different time points.

### Materials:

Three different milk bases each comprising different sweeteners (Maltitol, Isomaltulose and Erythritol) were prepared according to the tables below.

TABLE 21
Milk Base with Maltitol (MB-M)

| Ingredient | Source | w/w % |
|---|---|---|
| Fresh Milk | Sanyuan (3.4% fat, 3.3% protein) | 92.90 |
| Sugar | Taigu | 0.73 |
| Maltitol | Roquette | 4.50 |
| Clearam CJ 5025 | Roquette | 1.30 |
| WPC 80 | Arla | 0.40 |
| Pectin 106-AS YA | CP Kelco | 0.10 |
| Agar YN-03 | LiBangDa | 0.10 |

TABLE 22
Milk Base with Isomaltulose (MB-I)

| Ingredient | Source | w/w % |
|---|---|---|
| Fresh Milk | Sanyuan (3.4% fat, 3.3% protein) | 92.90 |
| Sugar | Taigu | 0.73 |
| Isomaltulose | HIYEE | 4.50 |
| Clearam CJ 5025 | Roquette | 1.30 |
| WPC 80 | Arla | 0.40 |
| Pectin 106-AS YA | CP Kelco | 0.10 |
| Agar YN-03 | LiBangDa | 0.10 |

TABLE 23
Milk Base with Erythitol (MB-E)

| Ingredient | Source | w/w % |
|---|---|---|
| Fresh Milk | Sanyuan (3.4% fat, 3.3% protein) | 92.90 |
| Sugar | Taigu | 0.73 |
| Erythritol | Cargill | 4.50 |
| Clearam CJ 5025 | Roquette | 1.30 |
| WPC 80 | Arla | 0.40 |
| Pectin 106-AS YA | CP Kelco | 0.10 |
| Agar YN-03 | LiBangDa | 0.10 |

The following cultures were used for fermentation at a concentration of 100 u/t:

F-DVS YoFlex® Acidifix™ 1.0 (batch 3586293, Chr. Hansen A/S).

F-DVS LGG® (batch 3584797, Chr. Hansen A/S).

### Method:

Milk bases prepared according to the tables above were pasteurized at 134° C. for 4 seconds.

For first fermentation 100 units/ton of YoFlex®Acidifix® culture were inoculated in the milk base and fermentation was conducted at 43° C. until the first target pH 4.50 was reached.

The curd was broken and the yogurt base was heat treated at 75° C. for 49.2 seconds.

Second fermentation was carried out with inoculation of 5.0E+06 cfu/g of LGG® in the heat treated yogurt base prepared by the first fermentation. The second fermentation was conducted at 25° C. and terminated after 72 h (Day 0).

The product was stored at the temperatures 25° C., 37° C. and 42° C. and titratable acidity, TA (OT) was measured during storage according to China national standards (GB 5009.239-236 National food safety standard Determination of acidity in foods).

### Results:

TABLE 24
TA during storage at an ambient temperature, 25° C.

| Milkbase | Day 0 | Week 1 | Week 4 |
|---|---|---|---|
| MB-M | 69.7 | 78.3 | 82.6 |
| MB-I | 70.3 | 78.2 | 86.0 |
| MB-E | 69.3 | 71.3 | 73.6 |

TABLE 25
TA during storage at 37° C.

| Milkbase | Day 0 | Week 1 | Week 2 | Week 4 | Week 6 |
|---|---|---|---|---|---|
| MB-M | 69.7 | 82.7 | 85.5 | 93.5 | 104.7 |
| MB-I | 70.3 | 85.7 | 89.6 | 99.4 | 111.1 |
| MB-E | 69.3 | 75.9 | 76.2 | 78.7 | 79.1 |

TABLE 26
TA during storage at 42° C.

| Milkbase | Day 0 | Week 1 | Week 2 | Week 3 | Week 4 | Week 6 |
|---|---|---|---|---|---|---|
| MB-M | 69.7 | 81.2 | 82.9 | 86.7 | 91.1 | 110.2 |
| MB-I | 70.3 | 82.0 | 85.0 | 90.4 | 97.7 | 109.4 |
| MB-E | 69.3 | 74.2 | 76.2 | 74.8 | 76.7 | 80.1 |

Products made by the two-step fermentation method result in a post-acidification that varies with the different sweeteners used.

### Example 6—Use of an Alternative Lactose-Deficient Strain for the Second Fermentation

The method of the invention was conducted using the lactose-deficient strain L. casei 02 for the 2^{nd} fermentation.

### Materials:

Two different milk bases with different amount of sucrose were prepared according to Table 3 in example 1 (MB1 comprising no sucrose) and Table 11 in example 3 (MB2 comprising 0.75% sucrose).

The following cultures were used for fermentation at a concentration of 100 u/t:

F-DVS YoFlex® Acidifix™ 1.0 (batch 3586293, Chr Hansen A/S)

F-DVS YF-L904 (batch 3551191, Chr Hansen A/S)

F-DVS L. casei 02 (batch 3565988, Chr Hansen A/S)

TABLE 27
Fermentation set up

| Sample | Milk base | Sucrose | 1. Culture | 2. Culture |
|---|---|---|---|---|
| S7 | MB1 | — | F-DVS YF-L904 | F-DVS L. casei 02 |
| S8 | MB2 | 0.75% | F-DVS Acidifix 1.0 | F-DVS L. casei 02 |

### Method:

Milk bases were prepared according to the tables and pasteurized at 134° C. for 4 seconds.

First fermentation—inoculate YF-L904 100 u/T (units/ton) in MB1, Acidifix 100 u/T (units/ton) in MB2, ferment at 43° C. until the first target pH 4.50 was reached.

Break curd and heat treat yoghurt base at 75° C. for 25 seconds.

Second fermentation—inoculate aseptically F-DVS L. casei 02 with dosage 0.00663% which equal to 5.5E+6 cfu/g in heat treated yoghurt base prepared by the first fermentation (time t0).

Conduct the second fermentation at 25° C. until a stable pH was reached at a second target pH at approximately pH 4.2-4.3 (time t1).

Storage at the temperatures of 25° C., 37° C. and 42° C.

Cell counts were determined as described in example 1.

### Results:

TABLE 28
Post-acidification measured as pH for samples stored at 25° C.

| Sample | t0 | t1 | 1 Mth | 2 Mth | 3 Mth |
|---|---|---|---|---|---|
| S7 | 4.51 | 4.20 | 3.81 | 3.75 | 3.81 |
| S8 | 4.48 | 4.27 | 4.28 | 4.23 | 4.27 |

TABLE 29
Cell counts for samples stored at 25° C.

| Sample | t0 | 1 Mth | 2 Mth | 3 Mth |
|---|---|---|---|---|
| S7 | 4.00E+5 | 2.43E+8 | 6.00E+6 | 3.15E+6 |
| S8 | 2.80E+5 | 3.47E+8 | 2.16E+8 | 2.06E+8 |

TABLE 30
Post-acidification measured as pH for samples stored at 37° C.

| Sample | t0 | W 1 | W 2 | W 3 | W 4 | W 5 | W 6 | W 7 | W 8 |
|---|---|---|---|---|---|---|---|---|---|
| S7 | 4.50 | 3.80 | 3.79 | 3.82 | 3.82 | 3.82 | 3.76 | 3.78 | 3.77 |
| S8 | 4.56 | 4.29 | 4.17 | 4.35 | 4.34 | 4.34 | 4.27 | 4.31 | 4.25 |

TABLE 31
Cell counts for samples stored at 37° C.

| Sample | t0 | W 1 | W 2 | W 3 | W 4 | W 5 | W 6 | W 7 | W 8 |
|---|---|---|---|---|---|---|---|---|---|
| S7 | 4.0E+5 | 4.7E+8 | <1.0E+6 | <1.0E+4 | <1.0E+2 | 510 | <10 | <10 | — |
| S8 | 2.8E+5 | 4.7E+8 | 1.2E+8 | 1.13E+8 | 3.5E+7 | 2.35E+7 | 2.8E+6 | 2.82E+7 | 2.24E+7 |

TABLE 32
Post-acidification measured as pH for samples stored at 42° C.

| Sample | t0 | W1 | W2 | W3 | W4 |
|---|---|---|---|---|---|
| S7 | 4.50 | 3.92 | 3.87 | 3.95 | 3.94 |
| S8 | 4.56 | 4.30 | 4.22 | 4.27 | 4.22 |

TABLE 33
Cell counts for samples stored at 42° C.

| Sample | t0 | W1 | W2 | W3 | W4 |
|---|---|---|---|---|---|
| S7 | 4.0E+5 | 1.6E+7 | <1.0E+5 | <1.0E+3 | <10 |
| S8 | 2.8E+5 | 6.4E+6 | 1.0E+6 | 1.36E+6 | 1.81E+6 |

Both S7 and S8 reached a stable level of pH during storage at 25° C., 37° C., 42° C. However S7 takes longer time to reach such level of pH, and the pH level is lower than for S8. This is an indication that the type and amount of monosaccharide left by the starter culture in the first fermntation are different in S7 as compared to S8. L. casei 02 shows a similar effect as that observed for LGG®.

In both S7 and S8, L. casei 02 can grow to higher cell count from the inoculation level, however the stability at different temperature varies. The most stable cell count is observed for S8 at 25° C. where the cell count is above 1.0E+8 cfu/g for 3 months.

1. A method for producing a fermented milk product with live bacteria comprising the steps of:
a) Providing a milk base comprising at least one carbohydrate and a first culture comprising one or more lactic acid bacteria strains capable of metabolizing said carbohydrate and generating at least one monosaccharide;
b) fermenting the milk base at a first temperature of no more than 45° C. for a period of time until a first target pH of no more than pH 4.7 is reached to obtain a first fermented milk base comprising the at least one monosaccharide;
c) treating the first fermented milk base whereby the strains comprised in the first culture are inactivated or removed;
d) adding a second culture comprising one or more lactic acid bacteria strains to the treated first fermented milk base, wherein said strains are lactose-deficient and capable of metabolizing the at least one monosaccharide generated during the first fermentation;
e) fermenting the treated first fermented milk base at a second temperature of no more than 45° C. for a period of time until a second target pH of no more than pH 4.4 is reached to obtain a fermented milk product, wherein the second target pH is determined by depletion of the at least one monosaccharide and wherein the second target pH is lower than the first target pH.

2. The method according to claim 1, wherein the at least one carbohydrate in the milk base are selected from lactose, sucrose, maltose, or trehalose.

3. The method of any of the preceeding claims, wherein the at least one carbohydrate in the milk base is added to the milk base.

4. The method of the preceding claim, wherein the amount of the at least one carbohydrate is depleted during the first fermentation.

5. The method of any of the preceeding claims, wherein the one or more lactic acid bacteria strains of the first culture are selected from the genus Streptococcus such as S. thermophilus, or the genus Lactobacillus such as L. delbrueckii subsp. bulgaricus.

6. The method of any of the preceding claims, wherein the one or more lactic acid bacteria strains of the first culture are lactose-deficient.

7. The method of claim 6, wherein the lactose-deficient strain is selected from the group consisting of: DSM28952, DSM28953, DSM28910, DSM32600, and DSM32599.

8. The method of any of the preceding claims, wherein the first target pH is no more than pH 4.70:4.65; 4.60; 4.55; 4.50; 4.45; 4.40; or in the range of pH 4.70-4.00; 4.70-4.10; 4.70-4.20; 4.70-4.30; 4.70-4.40; 4.70-4.45; 4.65-4.50; 4.60-4.55; or is about 4.70:4.65; 4.60; 4.55; 4.50; 4.45; or 4.40.

9. The method of any of the preceding claims, wherein the first temperature is no more than 25; 30; 35; 36; 37; 38; 39; 40; 41; 42; 43; 44; 45° C.; or in the range of 20-45; 25-45; 30-45; 40-45; 25-40; 30-40; 35-40° C.; or is about 20; 25; 30; 35; 36; 37; 38; 39; 40; 41; 42; 43; 44; 45° C.

10. The method of any of the preceding claims, wherein the treatment of the first fermented milk base is a treatment with heat, wherein the heat treatment is conducted in the range of 65-75° C. for at least 1-30 minutes; or at at least 60; 65; 70; or 75° C. for 1; 5; 10; 15; 20; 25; or 30 minutes; or in the range of 70-90 for 10-50 seconds; or at at least 70; 75; 80; 85; or 90° C. for at least 10; 15; 20; 25; 30; 35; 40; 45; or 50 seconds; or in the range of 65-90° C.; 70-85° C.; 75-80 for 10-50 seconds; or for 75° C. for 25 seconds; 75° C. for 50 seconds.

11. The method of any of the preceding claims, wherein the second target pH is no more than pH 4.5; 4.4; 4.3; 4.2; 4.1; 4.0; 3.9; 3.8; 3.7; 3.6; 3.5 or is in the range of pH 4.50-3.50; 4.50-4.05; 4.45-4.10; 4.45-4.15; 4.40-4.20; 4.40-4.25; 4.35-4.30; 4.00-3.50; 3.95-3.50; 3.90-3.55; 3.85-3.60; 3.80-3.65; 3.75-3.60; or is about pH 4.40; 4.35; 4.30; 4.25; 4.20; 4.15; 4.10; 4.05; 4.00; 3.90; 3.80; 3.70; 3.60; 3.50.

12. The method of any of the preceding claims, wherein the one or more lactic acid bacteria of the second culture is selected from the group consisting of bacteria of the genus Lactobacillus, such as Lactobacillus acidophilus, Lacticaseibacillus paracasei, Lacticaseibacillus rhamnosus, Lacticaseibacillus casei, Lactobacillus delbrueckii, Lactiplantibacillus plantarum, Limosilactobacillus fermentum, Limosilactobacillus reuteri and Lactobacillus johnsonii; the genus Bifidobacterium, such as Bifidobacterium longum, Bifidobacterium adolescentis, Bifidobacterium bifidum, Bifidobacterium breve, Bifidobacterium animalis subsp. lactis, Bifidobacterium dentium, Bifidobacterium catenulatum, Bifidobacterium angulatum, Bifidobacterium magnum, Bifidobacterium pseudocatenulatum and Bifidobacterium infantis; or the genus Streptococcus such as S. thermophilus.

13. The method of the preceeding claim, wherein the one or more lactic acid bacteria of the second culture is a probiotic bacteria.

14. The method of the preceeding claim, wherein the bacteria is ATCC53103, CNCM I-2116, and/or DSM16572.

15. The method of any of the preceding claims, wherein the pH of the fermented milk product changes less that 0.80; 0.70; 0.60; 0.50; 0.40; 0.35; 0.30, 0.25, 0.20, 0.18, 0.16, 0.14, 0.12, 0.10, 0.09, 0.08, 0.07, 0.06, 0.05, 0.04, 0.03, 0.02 or 0.01 pH units after storage for 6 month at 25° C.

16. The method of any of the preceding claims, wherein fermented milk product comprise at least 1.0E+03; 1.0E+04; 1.0E+05; 1.0E+06; 1.0E+07; 1.0E+08; 1.0E+09; or at least 1.0E+10 cfu/g live bacteria after storage for 6 month at 25° C.

17. The method of any of the preceeding claims, wherein one or more lactic acid bacteria of the second culture are able to proliferate and increase the cell count during the second fermentation, or both during and after the second fermentation.

18. The method according to the preceeding claim, wherein the cell count is increased with 0.5; 1.0; 1.5; 2.0; 2.5; or 3.0 logs.

19. A fermented milk product manufactured by the method according to any of claims 1-18.

20. The product according to claim 19, wherein the fermented milk product comprises probiotic bacteria of at least 1.0E+05; 1.0E+06; 1.0E+07; 1.0E+08; 1.0E+09; 1.0E+10; 1.0E+11; 1.0E+12 cfu/serving.
